(19) United States
(12) Patent Application Publication
(10) Pub. No.: US 2004/0158489 A1
(43) Pub. Date: Aug. 12, 2004

(54) Method and system for increasing customer traffic and loyalty

(76) Inventor: Nathan J. Rogers, Beaumont, TX (US)

Correspondence Address: JENNIFER S. SICKLER, 1000 LOUISIANA, SUITE 3400, HOUSTON, TX, 77002, US

(21) Appl. No.: 10/364,626

(22) Filed: Feb. 11, 2003

(51) Int. Cl. G06F 17/60

(52) U.S. Cl. 705/14

(57) ABSTRACT

The present invention is a method and system for increasing customer traffic and loyalty by conducting a random drawing and allowing the winners to choose between a cash prize and a store credit, wherein the store credit has a value that is a multiple of cash prize. No purchase is required in order for a customer to be eligible to win a prize.

### FIELD OF THE INVENTION

The present invention relates generally to the field of retail customer relations and more specifically to a method of increasing initial and repeat visits of customers by offering incentives.

### BACKGROUND OF THE INVENTION

Customer loyalty and shopping-frequency have long been recognized as important to the success of a number of different types of retail business ventures. As a result, incentive programs have been developed to attract additional customers and to instill loyalty in the existing client base. These include discount coupons offered both in-store and elsewhere, such as newspaper advertisement. They have also included product giveaways that require the customer to register in some manner to be entered in a sweepstakes.

To date, the prizes associated with such promotional incentive programs have either been cash or specific merchandise, on the one hand, or a “gift certificate,” on the other. There is a need for a system that increases customer traffic and loyalty to retail establishments that allows a winning participant in a contest to choose between a cash prize and a store credit that has a value that is a multiple of the cash prize option. There is also a need for a system that accomplishes this goal without requiring the customer to make a purchase.

### SUMMARY OF THE INVENTION

Generally, and in one form, the present invention is a method for conducting a promotional campaign in a retail establishment that includes the steps of issuing one or more tokens that incorporate unique indicia, such that they may be distinguished from one another, to one or more customers. Such customers are not required to make a purchase to obtain a token. The unique indicia are recorded for use in the awarding of a prize. One or more winners are determined by selecting at random one or more of the unique indicia, such that the tokens bearing the selected indicia are considered to be winning tokens. In the most preferred embodiment, the holder of each winning token is then offered, in the alternative, a cash value prize or a store credit, wherein the store credit is a multiple of the cash value prize. The customer in possession of a winning token is allowed to elect to receive either the cash value prize or the store credit associated with the unique indicia on the customer's token.

### DETAILED DESCRIPTION OF THE INVENTION

The use of the subject matter of the present invention offers many variations in the implementation of the customer incentive program described here. Those skilled in the art will appreciate these variations and will understand that they are part of the present invention, even if not explicitly described. The following description is demonstrative and in no way meant to limit the scope of the present invention.

The present invention offers a variety of ways to increase the foot traffic within a retail establishment. It allows a merchant to increase the loyalty of those shopping in his establishment, and thus the likelihood that a given customer will return to the store in the future.

In one form, the invention is a method that involves issuing tokens containing unique indicia that will allow one or more customers to be chosen to receive a prize for having visited the store. These tokens may take the form of lottery-type tickets that are embossed with a unique identifier, for example a number. They may also take the form of a card or other means that is capable of interacting with an electronic device, such as a card reader, that will record the time and frequency of the registration. In any event, the merchant must track or record the tokens that have actually been distributed so that the associated unique indicia may be pooled for the selection of one or more winners of a drawing.

The drawings for the distribution of prizes may be conducted on whatever schedule the merchant chooses. Examples of schedules would include daily, weekly, monthly or annually. Clearly, the more often that the tokens are used to distribute prizes, the more effective the promotion will be in terms of forming the idea in the minds of the customer that there is an additional benefit to shopping in the store beyond the prices and range of merchandise available.

To be effective, it is felt that the promotional method of the present invention should be made available to customers regardless of whether they ultimately make a purchase. This recognizes the fact that it may be desirable to “prime the pump” with customers and get them in the habit of returning to the store and being rewarded, even if they choose to buy nothing on one or more of those visits.

The distribution of the tokens associated with a promotional program of the present invention may take many forms. “Greeters” could distribute the tokens as the customers enter the store, or they could be taken from a device designed to dispense such items. They may also be distributed in a more formal manner by requiring registration of the person receiving the tokens. This information could be used for further marketing efforts by establishing the demographics of those entering the store. It may also allow the merchant to contact winners that are not present for the drawing. It is recognized that some customers are resentful of having to give out personal information in order to enter into a sweepstakes or drawing, and merchants will have to weigh the value of the additional information with the value of the good will potentially lost in acquiring it.

The period for which the distributed tokens are valid for participation in a given drawing may also be varied. For example, there may be a prize drawing on a daily basis and only those tokens handed out on the same day as the drawing would be eligible. Preferably, there are weekly drawings, and only those tokens distributed since the last drawing are eligible to win. When a reusable token, such as a card that may interact with a card reader is used, then the eligibility may be predicated on the registration of the card with the card reader during the chosen effective period to make the holder eligible for the drawing. Alternatively, once entered, each token may remain active for all future drawings.

The merchant may also alter the eligibility for prizes by limiting the number of times that an individual may be registered for a particular drawing. For example, a person may be limited to a single entry. When the distributed tokens are things such as lottery-type tickets, this may be problematic, since efforts to restrict an individual to a single ticket may result in the loss of good will. The use of a semi-permanent token, such as a card type device, could alleviate this problem. A card reader could be programmed so that it only registers an individual token once, regardless of the number of times the card is actually passed through the reader. The card reader may be placed in a prominent location that allows the customers to register themselves without any participation by store personnel. It will be appreciated that placing the reader away from the store entrance would increase the chances of the customer seeing merchandise they are interested in and increasing the chances of making a sale.

One feature of the present invention is making available alternative prizes to those selected as winners of the drawings. As part of the promotional programs of the present invention, the winners of the drawings will have the choice of the cash value of the prize as had been predetermined by the merchant, or in the alternative, they may elect to take a store credit in an amount that is a multiple of the value of the case prize. For example, if the prize for which the customer's unique token is selected is $100, they may elect to take a prize that is worth $250 in store credit. In this example, the value of the store-credit prize to the customer is a multiple of 2.5 times the value of the cash prize. The magnitude of the multiple is determined in advance by the merchant and will take into account, among other factors, the profit margin that the store maintains. By operating the promotional program in this manner, everyone involved may benefit; the winning customer receives additional value and the merchant's outlay is reduced because his actual cost is less than the face value of the store credit given to the customer. In an alternative embodiment, the prize may be a combination of cash and store credit.

The selection of the winning tokens may be performed by any appropriate method, including, but not limited to, a drawing that is conducted manually or with the aid of a computer that has stored all of the unique indicia. It is a feature of the present invention that the award of prizes is not based on the amount of money that a customer has spent with the store. The present invention is directed toward getting more customers into a retail outlet, not to rewarding customers for the magnitude of their spending.

The merchant may set the rules for the promotion such that the holder of a winning token does not have to be present at the time of the drawing in order to win. For example, the winning token indicia may be posted for a set period of time in which the holder may claim their prize. Alternatively, the promotion rules may require the customer to be present to win. If the merchant chooses, it may contact the holder directly if such information has been provided to them.

While specific alternatives to steps of the invention have been described herein, additional alternatives not specifically disclosed but known in the art are intended to fall within the scope of the invention. Thus, it is understood that other applications of the present invention will be apparent to those skilled in the art upon the reading of the described embodiments and consideration of the appended claims.

What is claimed:

1. A method for conducting a promotional campaign in a retail establishment comprising the steps of:
issuing a token, incorporating a unique indicia, to at least two customers independent of any purchase by the customers;
recording the unique indicia for use in awarding a prize;
selecting at random at least one of the unique indicia, such that the tokens bearing the selected indicia are considered to be winning tokens;
offering a choice of prizes for each winning token from which the customer chooses.

2. The method of claim 1, wherein the step of offering a choice of prizes comprises offering, in the alternative, a cash value prize or a store credit for each winning token, wherein the store credit is a multiple of the cash value prize.

3. The method of claim 1, wherein the tokens are valid for a finite time period.

4. The method of claim 1, wherein the tokens are valid for one day.

5. The method of claim 1, wherein the tokens are valid for one week.

6. The method of claim 1, wherein the tokens are issued manually.

7. The method of claim 1, wherein the tokens are issued mechanically.

8. The method of claim 1, wherein the recording step is accomplished by the customer.

9. The method of claim 8, wherein the recording step is repeated by the customer for entry into additional drawings.

10. The method of claim 1, wherein the selection is accomplished by a drawing.

11. The method of claim 10, wherein the drawing is accomplished with the aid of a computer.

12. A system for increasing customer loyalty in a retail establishment comprising:
a means for issuing a token, incorporating a unique indicia, to at least two customers;
a means for recording the unique indicia for use in awarding a prize;
a means for selecting at random at least one of the unique indicia, such that the tokens bearing the selected indicia are considered to be winning tokens;
a means for offering a choice of prizes for each winning token from which the customer chooses.

13. The system of claim 12, wherein the means for offering a choice of prizes comprises offering, in the alternative, a cash value prize or a store credit for each winning token, wherein the store credit is a multiple of the cash value prize.

14. The system of claim 12, wherein the tokens are valid for a finite time period.

15. The system of claim 12, wherein the tokens are valid for one day.

16. The system of claim 12, wherein the tokens are valid for one week.

17. The system of claim 12, wherein the tokens are issued manually.

18. The system of claim 12, wherein the tokens are issued mechanically.

19. The system of claim 12, wherein the recording step may be accomplished by the customer.

20. The system of claim 19, wherein the recording step may be repeated by the customer for entry into one or more additional drawings.

21. The system of claim 12, wherein the selection is accomplished by a drawing.

22. The system of claim 21, wherein the drawing is accomplished with the aid of a computer.

23. The system of claim 12, wherein the means for issuing a token is manual.

24. The system of claim 12, wherein the means for issuing a token is automated.

25. The system of claim 12, wherein the means for recording includes retaining a portion of the token.

26. The system of claim 12, wherein the means for recording includes a bar code scanner.

27. The system of claim 12, wherein the means for selecting includes a manual random selection of the indicia associated with one or more tokens.

28. The system of claim 12, wherein the means for selecting includes an automated random selection of the indicia associated with one or more tokens.
